(19) United States
(12) Patent Application Publication
(10) Pub. No.: US 2003/0105958 A1
(43) Pub. Date: Jun. 5, 2003

(54) Command script instrumentation for logging command execution and the protection of sensitive information

(75) Inventor: James M. McArdle, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 10/005,132

(22) Filed: Dec. 5, 2001

(51) Int. Cl. H04L 9/00; G06F 9/44

(52) U.S. Cl. 713/167; 717/115

(57) ABSTRACT

The invention provides a method of command script instrumentation for clear logging of command execution and the protection of sensitive information. The method comprises defining a common log file, writing at least one command of a command script to the common log file, writing parameters of each logged command to the common log file, and providing a parallel command string or parameter in place of one containing sensitive information.

### RELATED APPLICATION

This application relates to U.S. Patent Application (IBM Dkt. No. AUS820011290) entitled Capturing Command Execution Status, by James M. McArdle, filed concurrently herewith.

### COPYRIGHT NOTICE

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### FIELD OF THE INVENTION

This invention relates to logging the command execution in command scripts. More specifically, the invention relates to instrumenting a command script to clearly log the information relating to the steps of its execution while still protecting sensitive information.

### BACKGROUND OF THE INVENTION

Frequently command scripts provide an effective means to perform a computer task. Application designers often utilize the power of such scripts and distribute them as an integrated part of their product.

Commands performed by a command script are often recorded by a log file, providing valuable information for the design phase of an application, as well as for a review of a script execution after errors occur.

While logging the commands to a file may be useful, it also may be problematic. For example, when a command contains a password, writing that command to the log file may pose a security risk. However, failing to write any command containing sensitive information to the log file may result in an incomplete log, one that fails to portray accurately all the executed steps.

It would be desirable to have a system and method for accurately logging the steps executed by a script, while still protecting sensitive information.

### BRIEF SUMMARY OF THE INVENTION

One aspect of the invention provides a method of logging command execution in a command script, and protecting sensitive information. The method comprises the use of a common log file to store the command execution information and any parameters supplied for that command execution. When a command or parameter holds sensitive information a parallel command string or parameter may be used in place of the original. This parallel command string or parameter may be written to the log instead of the one containing the sensitive information. An error handling routine may be employed to write and catch any command returning a code above a certain threshold value. The error handling routine may then write the return code to the common log file. Each command may be assigned a command number for tracing execution and error conditions, and that command number may be written to the common log file.

Another aspect of the invention provides a computer readable medium storing a computer program. The computer readable medium may comprise computer readable code for clearly logging command execution in a command script, and protecting sensitive information. The computer readable code may use a common log file to store the command execution information and any parameters supplied with that command execution. When a command or parameter holds sensitive information a parallel command string or parameter may be used in place of the original. This command string or parameter is then written to the log instead of the one containing the sensitive information. An error handling routine may be employed to write and catch any command returning a code above a certain threshold value. The error handling routine may write the return code to the common log file. Each command may be assigned a command number for tracing execution and error conditions, and that command number may be written to the common log file.

Another aspect of the invention provides a system of logging command execution in a command script, and protecting sensitive information. The system comprises the use of a common log file to store the command execution information and any parameters supplied for that command execution. When a command or parameter holds sensitive information a parallel command string or parameter is used in place of the original. This command string or parameter is then written to the log instead of the one containing the sensitive information. An error handling routine may be employed to write and catch any command returning a code above a certain threshold value. The error handling routine may write the return code to the common log file. Each command may be assigned a command number for tracing execution and error conditions, and that command number may be written to the common log file.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWING

FIG. 1 is a flowchart representation of an embodiment of a command script implementation in accordance with the present invention;

FIG. 2 is a code sample illustrating an embodiment of the command script implementation of FIG. 1, in accordance with the present invention; and

FIG. 3 is a block diagram of an embodiment of a computer system for the command script implementation of FIG. 1 in accordance with the present invention.

### DETAILED DESCRIPTION OF THE PRESENTLY PREFERRED EMBODIMENTS

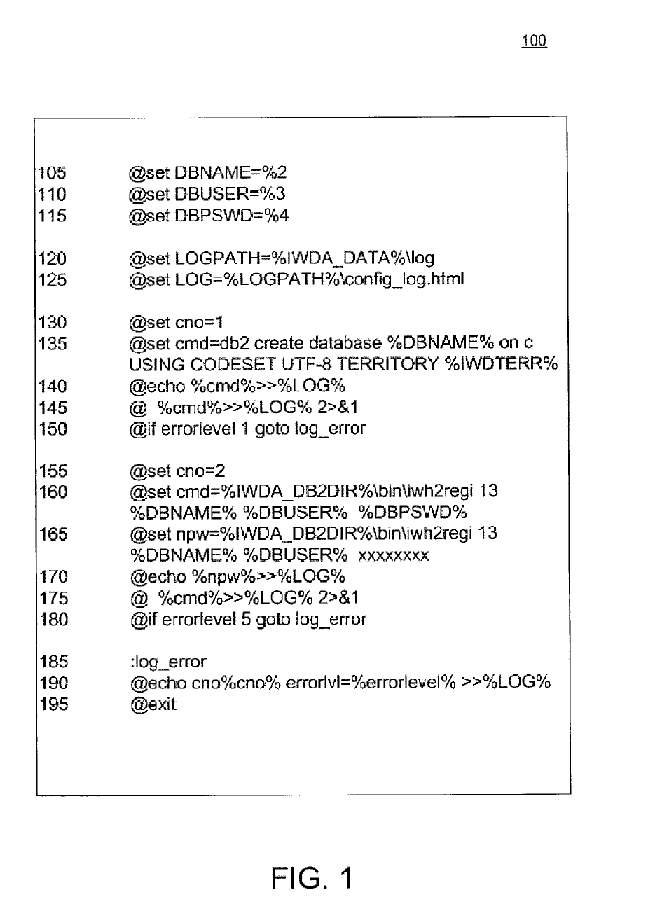

FIG. 1 is a flowchart representation of command script implementation 100. Using scripting languages known in the art, one implementation of the command script implementation 100 begins by assigning input parameters to named variables (Block 105). Named parameters are not required in the method or system, but may be employed for convenience. After named parameters are assigned a variable may be set specifying a location for a log file (Block 110). As the variable will be commonly accessible throughout the command script implementation 100, the file at that location may be referred to as a common log file. One embodiment of the invention may include setting a command number (Block 115), which is a variable that holds a number that may be useful for tracing the execution of the script. After all preliminary variable assignments are complete, a command string may be set to a variable (Block 120). The command script implementation 100 may then vary depending upon the information held in the command string (Block 125). If the command string does not include any sensitive information, it may be written to the common log file (Block 130). Sensitive information may be defined as a password, secret code, or any piece of information that may be of a generally restricted nature or deemed a security risk if publicly available. Sensitive information may also be personal or commercial information that some party may not want available outside of the intended use in executing the command script. If the command string does contain sensitive information, a parallel command string may be provided (Block 135) that does not contain the sensitive information. The parallel command string may then be written to the common log file (Block 140). After the command string, or parallel command string, has been written to the common log file, the command string may then be executed (Block 145). Upon execution, the command string may pass a return code to the command processor. This return code may be written to the common log file (Block 150). One implementation allows that the command number may be written to the common log file with the command string, the return code, or with both. One implementation allows the script to compare the return code of the command string against a known error code for that command string. If that return code indicates that an error has occurred, execution of the script may be passed to an error handling routine (Block 155).

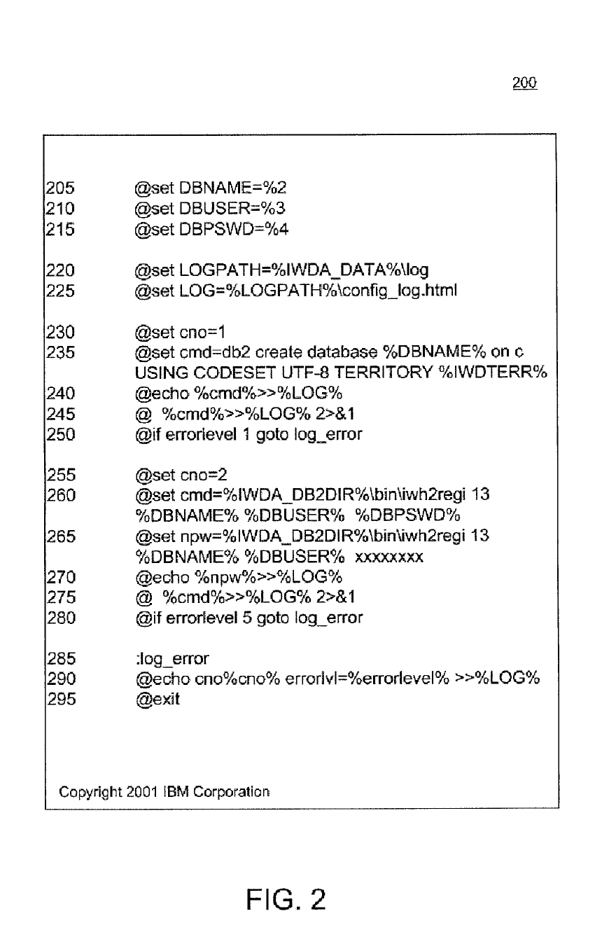

FIG. 2 is a code sample representing a command script 200 in accordance with the command script implementation 100 of FIG. 1. The command script 200 may begin by assigning named parameters as illustrated, in accordance with one embodiment of the present invention. Command script 200 may begin 205, 210, 215 by placing command line arguments into named parameters for ease of use within the script. A log file, which may be referred to as the script's common log file, is defined 220, 225 at the beginning of command script 200, providing a defined location and file that may be accessed throughout the script. The command script 200 might be called to create a file, move a file, or make a call to an application program. A command that achieves such an end, as opposed to those defining a parameter or common log file, may be referred to as a major command. The next block of code 230-250 may represent one possible execution of a major command. First, the major command is placed in a named parameter 235. The named parameter representing the major command string may be written to the common log file 240. Next the major command string may be executed and its return code may be written to the common log 245. The following block of code 255-280 may represent another possible execution of a major command. In this instance the major command string contains a password that was passed into the command script 215. A password is one example of a piece of sensitive information. Sensitive information may be defined as a password, secret code, or any piece of information that may be of a generally restricted nature or deemed a security risk if publicly available. Sensitive information may also be personal or commercial information that some party may not want available outside of the intended use in executing the command script. In the block of code representing a major command containing a password 255-280, again the command may be placed in a named parameter 260. In this instance a parallel command string may be constructed 265, replacing the password with non-sensitive information. Any string may replace the sensitive information; this embodiment uses the string ‘xxxxxxxx’. The parallel command string may be written to the common log file 270 in place of the major command string. The major command string may then be executed and its return code may be written to the common log file 275. One embodiment of the invention may provide a named parameter representing the major command number 230, 255. This major command number may aid tracing the command execution and error status. An embodiment of the invention may include an error handling routine 285-295. Each major command may return a different return code with a different number representing each error that occurs. The invention allows the script to check for error conditions 250, 280 and redirect execution to an error handling routine 185-195 if the return code of the major command is of a certain value. A programmer, when developing a command script using the method and system of this invention, may define the value representing an error. The error handling routine may write the error code to the common log file 290 and also may prompt the command script to exit execution 295. The error handling routine may also write the command number, if one has been assigned, to the common log 290.

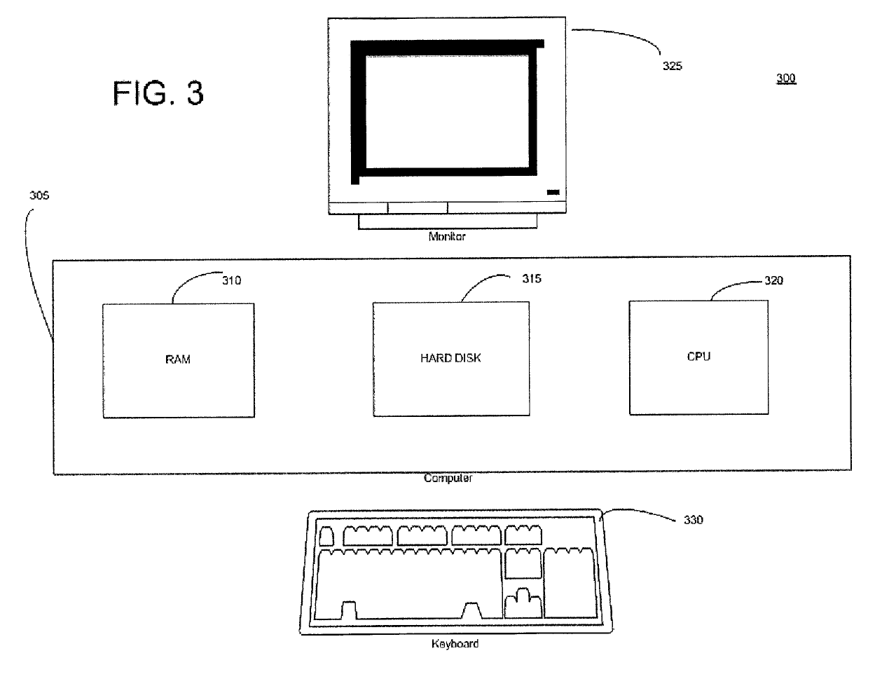

FIG. 3 is a block diagram of an embodiment of a computer system 300 for the command script implementation of FIG. 1. Computer system 300 may comprise peripheral elements such as a monitor 325 and a keyboard 330 that may be used in conjunction with the computer 305. The computer 305 may include random access memory (RAM) 310, a hard disk 315, and a central processing unit (CPU) 320. Command script 200 may be stored on the hard disk of computer 305, read into RAM 310, and its commands executed the CPU 315 by a command processor. One embodiment of this invention allows that the computer system 300 may be in the form of a personal computer, network workstations, network server, mainframe, mainframe slave station, laptop computer, PDA (Personal Digital Assistant), cell phone or any other form of computer system capable of processing command scripts known in the art.

The above-described methods and implementation of logging command execution in a command script are example methods and implementations. These methods and implementations illustrate one possible approach for logging command execution in a command script. The actual implementation may vary from the method discussed. Moreover, various other improvements and modifications to this invention may be evident to those skilled in the art, and those improvements and modifications fall within the scope of this invention as set forth below.

While embodiments of the invention disclosed herein are presently preferred, various changes and modifications can be made without departing from the spirit and scope of the invention. The scope of the invention is indicated in the appended claims, and all changes that come within the meaning and range of equivalents are intended to be embraced therein.

1. A method of instrumenting logging of command execution of a command script, comprising:
defining a common log file;
writing at least one command of a command script to the common log file; and
providing a parallel command string to replace the command when it contains sensitive information, prior to it being written to the common log file.

2. The method of claim 1 further comprising:
invoking an error routine that writes a return code of a command to the common log file when the return code is of a certain value.

3. The method of claim 1 wherein the command is assigned a command number for tracing execution and error conditions.

4. The method of claim 3 wherein the command number is written to the common log file.

5. The method of claim 1 further comprising:
writing parameters of each logged command to the common log file.

6. The method of claim 1 further comprising:
replacing a parameter containing sensitive information with a parallel parameter, prior to it being written to the common log file.

7. A computer readable medium storing a computer program that allows instrumenting logging of command execution of a command script, comprising:
computer readable code for defining a common log file;
computer readable code for writing at least one command of a command script to the common log file; and
computer readable code for providing a parallel command string to replace the command when it contains sensitive information, prior to it being written to the common log file.

8. The computer readable medium of claim 7 further comprising computer code for invoking an error routine that writes a return code of a command to the common log file when the return code is of a certain value.

9. The computer readable medium of claim 7 wherein the command is assigned a command number for tracing execution and error conditions.

10. The computer readable medium of claim 9 wherein the command number is written to the common log file.

11. The computer readable medium of claim 7 further comprising:
computer code for writing parameters of the command to the common log file.

12. The computer readable medium of claim 7 further comprising:
computer code replacing a parameter containing sensitive information with a parallel parameter, prior to it being written to the common log file.

13. A system of instrumenting logging of command execution of a command script, comprising:
means for defining a common log file;
means for writing at least one command of a command script to the common log file; and
means for providing a parallel command string to replace the command when it contains sensitive information, prior to it being written to the common log file.

14. The system of claim 13 further comprising:
means for invoking an error routine that writes a return code of a command to the log file when the return code is of a certain value.

15. The system of claim 13 further comprising:
means for writing parameters of each logged command to the common log file.

16. The system of claim 13 further comprising:
means for replacing a parameter containing sensitive information with a parallel parameter, prior to it being written to the common log file.
